(19) United States
(12) Patent Application Publication
(10) Pub. No.: US 2026/0265111 A1
(43) Pub. Date: Sep. 10, 2026

(54) SILICA GLASS COMPRESSION MOLDING APPARATUS AND METHOD

(71) Applicants: ADVANCED SEMICONDUCTOR MANUFACTURING INNOVATION CENTER, WUXI XISHAN DISTRICT, Wuxi City (CN); HUNAN UNIVERSITY, Changsha (CN)

(72) Inventors: Shaohui YIN, Changsha (CN); Chengsong SHU, Changsha (CN); Xipeng GUO, Changsha (CN)

(21) Appl. No.: 19/488,472

(22) PCT Filed: Mar. 7, 2023
(86) PCT No.: PCT/CN2023/080006

§ 371 Date: Nov. 26, 2025

(30) Foreign Application Priority Data
Oct. 26, 2022 (CN) 202211320702.9

(51) Int. Cl. C03B 20/00; C03B 11/12

(52) U.S. Cl. CPC C03B 20/00; C03B 11/125

(57) ABSTRACT

Disclosed are a silica glass compression molding apparatus, and a method. The silica glass compression molding apparatus comprises: a mold, a stamping component, a heating component, a cooling component and a braking component; the heating component comprises a heating chamber, an electromagnetic heating unit and an infrared heating unit. By means of forming a composite heating system with the electromagnetic heating unit and the infrared heating unit, the present apparatus can quickly raise the temperature in the heating chamber to over 1500° C. within 10 minutes under the action of the composite heating system, and the heating temperature is more uniform. Compared with existing compression molding devices, this solves the molding condition of current glass compression molding devices not being able to heat to a high temperature of 1500° C., and heating efficiency is high.

### TECHNICAL FIELD

The present disclosure relates to the field of manufacturing precision optics, and particularly to a silica glass compression molding apparatus and method.

### BACKGROUND

High-purity fused silica glass has excellent spectral transmittance, extremely low thermal expansion coefficient and conductivity, extremely high chemical stability, radiation resistance, and long service life under extreme conditions, and is widely applied in components such as a gyroscope, a laser line mirror, a semiconductor mask and the like.

The fused silica glass is characterized by a high softening temperature, generally around 1500° C. However, a maximum compression molding temperature of presently available compression molding devices, both domestically and abroad, remains below 800° C., which is insufficient for the compression molding of fused silica glass optics.

### SUMMARY

In view of the above problems, the present disclosure aims at providing a silica glass compression molding apparatus and method overcoming or at least partially solving the above problems.

According to one aspect of the present disclosure, there is provided a silica glass compression molding apparatus, including a mold, a stamping component, a heating component, a cooling component and a braking component, wherein the mold includes a first mold and a second mold with molding surfaces, the first mold and the second mold are arranged opposite to each other, and the first mold is disposed above the second mold; the stamping component includes a pressing unit for stamping the first mold; the heating component includes a heating chamber, an electromagnetic heating unit and an infrared heating unit, wherein the electromagnetic heating unit is wound on the first mold and the second mold, the infrared heating unit is disposed on the heating chamber, and the heating chamber is configured to accommodate the first mold and the second mold within a chamber body under the control of the braking component; a supporting base is arranged between the pressing unit and the first mold, and when the first mold and the second mold are accommodated within the heating chamber, the heating chamber is abutted against the supporting base to form a closed environment; and the cooling component includes a water cooling unit and an air cooling unit, wherein the water cooling unit is arranged on an outer side wall of the heating chamber, the air cooling unit is arranged on one side of the supporting base away from the first mold, and the air cooling unit delivers cold air into the heating chamber through a via hole provided in the supporting base.

Optionally, the silica glass compression molding apparatus of the present disclosure further includes a vacuum pumping component disposed at one side of the supporting base away from the first mold, wherein the vacuum pumping component is configured to evacuate air in the heating chamber when the first mold and the second mold are accommodated within the heating chamber, such that a vacuum environment is formed within the heating chamber.

Optionally, the silica glass compression molding apparatus of the present disclosure further includes a cooling cover plate disposed at one side of the supporting base away from the first mold.

Optionally, in the silica glass compression molding apparatus of the present disclosure, the stamping component further includes a servo motor connected to the pressing unit, wherein the servo motor is configured to drive, via the pressing unit, the first mold to move towards or away from the second mold.

Optionally, in the silica glass compression molding apparatus of the present disclosure, a pressure sensor is connected to an electric cylinder shaft of the servo motor for detecting a compression molding force in a compression molding process.

Optionally, in the silica glass compression molding apparatus of the present disclosure, temperature sensors are arranged on the first mold and the second mold for detecting a temperature within the heating chamber in the compression molding process.

Optionally, in the silica glass compression molding apparatus of the present disclosure, a buckling unit is disposed on the supporting base and configured to fix the heating chamber to the supporting base when the first mold and the second mold are accommodated within the heating chamber.

Optionally, the silica glass compression molding apparatus of the present disclosure further includes a stand component, wherein the stand component includes a first platform, a second platform and a plurality of supporting columns for supporting the first platform and the second platform, the first platform and the second platform are arranged opposite to each other, the first platform is located above the second platform, and the heating chamber and a supporting platform are arranged between the first platform and the second platform.

Optionally, in the silica glass compression molding apparatus of the present disclosure, the servo motor is arranged on the first platform, and a channel is formed on the first platform for the electric cylinder shaft of the servo motor to pass through, and a guiding and positioning sleeve is disposed at a contact point between the electric cylinder shaft of the servo motor and the first platform for preventing an axial play of the pressing unit in the compression molding process.

Optionally, the silica glass compression molding apparatus of the present disclosure further includes a supporting I-beam and a compression molding apparatus bottom plate, wherein the stand component is fixed on the compression molding apparatus bottom plate by the supporting I-beam.

According to another aspect of the present disclosure, there is provided a silica glass compression molding method applied to the silica glass compression molding apparatus, including: fixing to-be-molded silica glass on a second mold, and fixing a die on a first mold; moving the heating chamber by the braking component such that the first mold and the second mold are accommodated within a chamber body; starting an electromagnetic heating unit and an infrared heating unit to heat the heating chamber to a preset temperature, and then stamping the first mold by the stamping component for a preset time; and cooling the heating chamber by the cooling component, and moving the heating chamber by the braking component to obtain stamped silica glass.

According to further aspect of the present disclosure, there is provided a computing device, including at least one process and a memory storing a program instruction, wherein the program instruction is configured to be suitable for execution by the at least one processor, and the program instruction includes an instruction for performing the method described above.

According to yet another aspect of the present disclosure, there is provided a readable storage medium storing a program instruction, wherein the program instruction, when being read and executed by a computing device, causes the computing device to perform the method described above.

According to a solution of the present disclosure, the apparatus forms a composite heating system by means of the electromagnetic heating unit and the infrared heating unit. The composite heating system enables a temperature inside the heating chamber to quickly exceed 1500° C. within 10 minutes while achieving superior heating temperature uniformity. Compared with an existing compression molding device, the silica glass compression molding apparatus solves the problem that an existing glass compression molding device cannot reach 1500° C. while providing high heating efficiency.

According to the solution of the present disclosure, the vacuum pumping component allows for the vacuum compression molding, which prevents the internal air-induced problems such as restricted flow of the glass within a mold cavity and mold oxidation during the compression molding and solves the problems such as incomplete filling and low surface figure accuracy in the glass compression molding process.

The foregoing description provides only an overview of the technical solution of the present disclosure. In order to clearly understand the technical means of the present disclosure, the technical solution can be implemented according to the detailed description of the specification. Moreover, in order to make the above and further objectives, features and advantages of the present disclosure more obvious and understandable, specific embodiments of the present disclosure will be listed below.

### BRIEF DESCRIPTION OF DRAWINGS

Various further advantages and benefits will become apparent to those ordinarily skilled in the art from the following detailed description of preferred embodiments. Accompanying drawings are only for the purpose of illustrating preferred embodiments and are not considered as limitations to the present disclosure. Moreover, the same reference numbers are used to represent the same components throughout the figures. In the figures:

FIG. 1 shows a schematic structural diagram of a silica glass compression molding apparatus 100 according to an embodiment of the present disclosure;

FIG. 2 shows a front view of a silica glass compression molding apparatus 100 according to an embodiment of the present disclosure;

FIG. 3 shows a schematic cross-sectional F-F view of a front view of a silica glass compression molding apparatus 100 according to an embodiment of the present disclosure;

FIG. 4 shows a side view of a silica glass compression molding apparatus 100 according to an embodiment of the present disclosure;

FIG. 5 shows a schematic cross-sectional E-E view of a side view of a silica glass compression molding apparatus 100 according to an embodiment of the present disclosure;

FIG. 6 shows a schematic isometric view of a silica glass compression molding apparatus 100 in an operating state according to an embodiment of the present disclosure;

FIG. 7 shows a schematic comparison view of a single heating manner and a composite heating manner according to an embodiment of the present disclosure; and

FIG. 8 shows a silica glass compression molding method 800 according to an embodiment of the present disclosure.

### DETAILED DESCRIPTION OF THE EMBODIMENTS

Exemplary embodiments of the present disclosure will be described in more detail below with reference to accompanying drawings. Although exemplary embodiments of the present disclosure are shown in accompanying drawings, it should be understood that the present disclosure may be implemented in various forms and should not be limited by embodiments described herein. In contrast, these embodiments are provided to enable a more thorough understanding of the present disclosure and to fully convey the scope of the present disclosure to those skilled in the art.

At present, fused silica optical glass is processed into optics mainly by adopting a traditional cold processing process, such as grinding and polishing. Such a processing manner is suitable for small-batch production, but is difficult to achieve large-batch stable production. In addition, for microstructural optics, the fused silica optical glass cannot be processed into structural optics due to size limitations of grinding and polishing tools. A glass compression molding technology is expected to effectively solve these problems and enable the large-batch, high-efficiency and high-precision production of glass optics. Such a technology applies a certain pressure to a glass blank through a mold under high-temperature and oxygen-free conditions by utilizing continuous and reversible thermal processing properties of the glass during its transition from a molten state to a solid state, thereby replicating a shape of a mold surface onto a glass surface softened by heating, and then performing annealing, cooling and solidification to obtain a desired optical design surface. Compared with the traditional cold processing technology, the glass compression molding technology belongs to deformation processing, which can significantly reduce raw material consumption and manufacturing costs while having the advantages of high repeatability, no pollution, net molding and batch production. Moreover, physical properties such as thermal stability, thermal expansion and hardness and optical properties such as refractive index and Abbe number of the compression molded glass optics are superior to the traditional cold processing technology. The glass compression molding technology creates a new era of large-scale and high-efficiency production of non-spherical glass lenses, thereby being considered as one of the most revolutionary technologies of manufacturing the optics in the world.

Although the compression molding technology can enable the large-batch, high-efficiency and high-precision production of the glass optics, an existing compression molding technology is mainly suitable for optical glass with a low transition point, typically with a Tg≤550° C. In contrast, the fused silica glass has a high softening temperature, typically around 1500° C. Therefore, compression molding of the fused silica glass optics cannot be enabled.

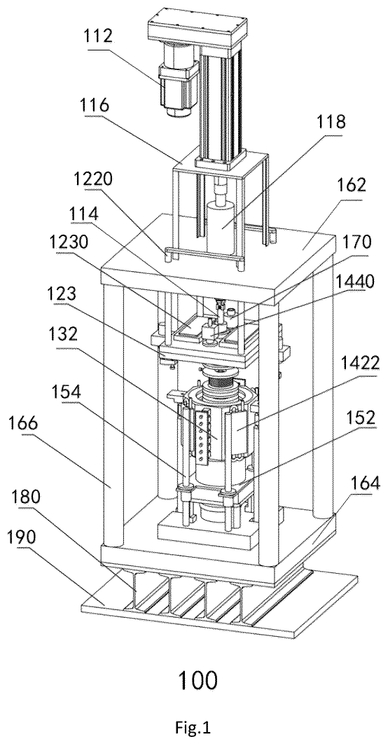

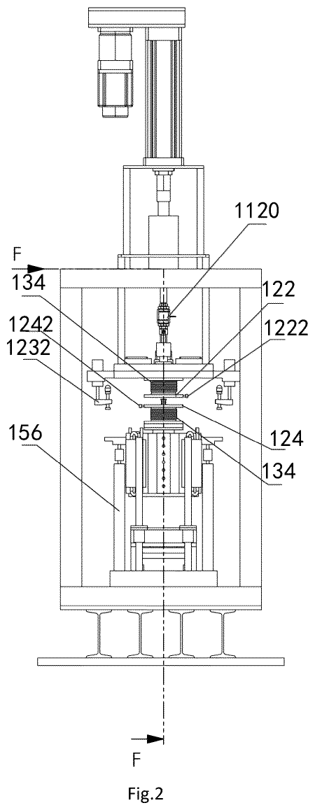

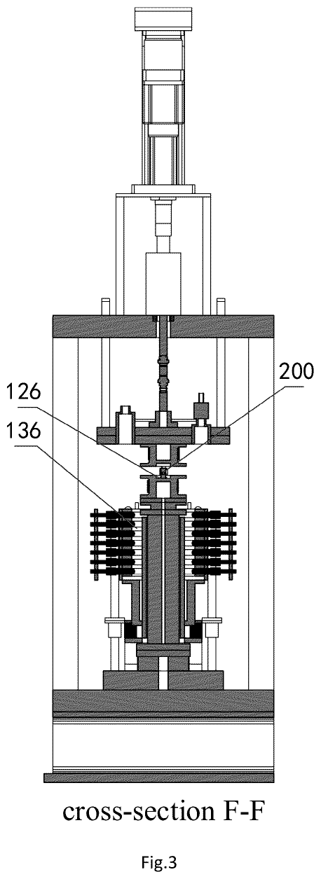

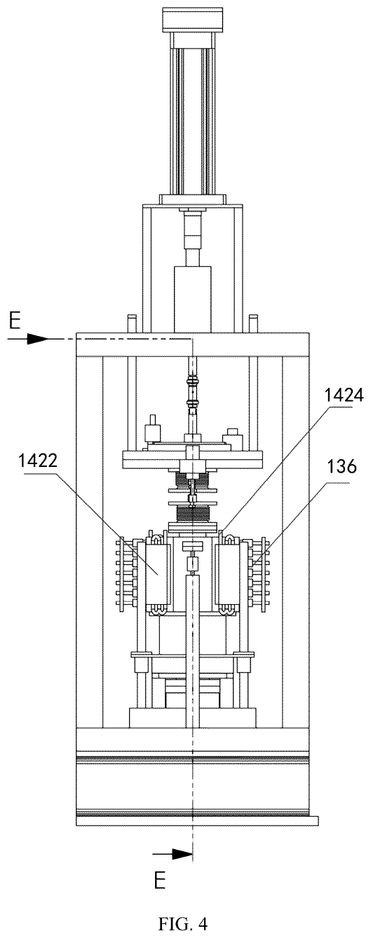

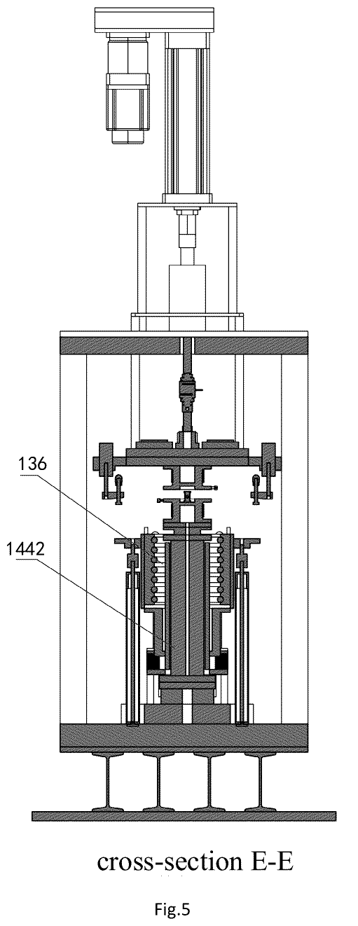

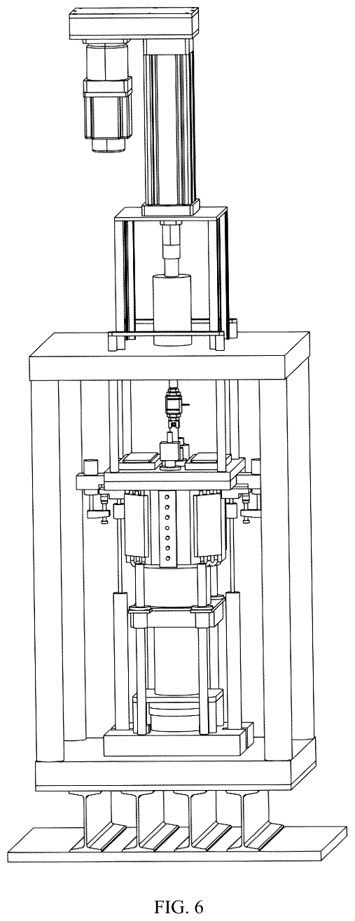

To solve the problems existing in the prior art, a solution of the present disclosure is presented. One embodiment of the present disclosure provides a silica glass compression molding apparatus 100. Reference is made to FIG. 1 to FIG. 6, wherein FIG. 1 shows a schematic structural diagram of a silica glass compression molding apparatus 100 according to an embodiment of the present disclosure, FIG. 2 shows a front view of a silica glass compression molding apparatus 100 according to an embodiment of the present disclosure, FIG. 3 shows a schematic cross-sectional F-F view of a front view of a silica glass compression molding apparatus 100 according to an embodiment of the present disclosure, FIG. 4 shows a side view of a silica glass compression molding apparatus 100 according to an embodiment of the present disclosure, FIG. 5 shows a schematic cross-sectional E-E view of a side view of a silica glass compression molding apparatus 100 according to an embodiment of the present disclosure, and FIG. 6 shows a schematic isometric view of a silica glass compression molding apparatus 100 in an operating state according to an embodiment of the present disclosure.

As shown in FIG. 1 to FIG. 6, the silica glass compression molding apparatus 100 includes a stamping component 110, a mold 120, a heating component 130, a cooling component 140, a braking component 150, a stand component 160, a vacuum pumping component 170, a supporting I-beam 180 and a compression molding apparatus bottom plate 190.

Among them, the stand component 160 includes an upper platform 162 (a first platform), a lower platform 164 (a second platform) and a plurality of supporting columns 166. The plurality of supporting columns 166 are evenly arranged between the upper platform 162 and the lower platform 164.

The stamping component 110 includes a servo motor 112, a pressing apparatus 114 disposed at one end of an electric cylinder shaft of the servo motor 112, a motor stand 116 and a guiding and positioning sleeve 118.

The motor stand 116 is disposed on an upper surface of the upper platform 162, and the servo motor 112 is disposed on the motor stand 116 to achieve servo loading in a compression molding process. Preferably, the servo motor is correspondingly matched with an encoder, which can calculate a loading displacement in real time in the compression molding process. A channel is formed on the upper platform 162 for the electric cylinder shaft of the servo motor 112 to pass through, and the guiding and positioning sleeve 118 is disposed at the channel to prevent an axial play of the stamping component in the compression molding process. In some embodiments, a pressure sensor 1120 is configured on the electric cylinder shaft of the servo motor 112 for detecting a compression molding force in the compression molding process.

The mold 120 includes an upper mold (a first mold) 122 and a lower mold (a second mold) 124, wherein the upper mold 122 is connected to the pressing apparatus 114 through a supporting base 123, and the pressing apparatus 144 can drive the upper mold 122 to move up or down through the servo motor 112. As shown in FIG. 2, the upper mold 122 and the lower mold 124 are configured in a columnar shape, with an accommodating chamber 126 formed between them for placing silica glass 200. The silica glass 200 can be fixed on the lower mold 124, and a die for shaping the silica glass 200 is fixed on the upper mold 122. When the upper mold 122 approaches the lower mold 124, a shape of the die can be formed on the silica glass 200 by an extruding force between the upper mold 122 and the lower mold 124.

In some embodiments, the supporting base 123 is provided with a loading guide rod 1220 at each of all four corners. One end of the loading guide rod 1220 is welded to the upper mold 122 while the other end thereof passes through the upper platform 162, so as to ensure that the supporting base 123 linearly moves in a vertical direction with extension and retraction of the electric cylinder shaft. The entire supporting base 123 can move up and down along the loading guide rod 1220.

The heating component 130 includes a heating chamber 132, an electromagnetic heating unit 134 and an infrared heating unit 136. The heating chamber 132 is a hollow structure with an opening at an upper portion thereof. When the molding apparatus 100 is in an operating state, the opening is abutted against the supporting base 123 for accommodating the upper mold 122 and the lower mold 124 within a chamber body.

The electromagnetic heating unit 132 is wound around the upper mold 122 and the lower mold 124, and can achieve electromagnetic heating after being powered on. A formula of a heating power generated in a metal mold via electromagnetic induction is described as follows:

$${P}_{d} = \frac{Q}{0.24 t} = \frac{cTG}{0.24 t} ,$$

wherein Q represents the total heat in joules (J), c represents an average specific heat capacity of a heated metal in kal/(kg. ° C.), T represents a temperature rise of the mold in degrees Celsius (C), G represents a total mass of the heated metal in kilograms (kg), and t represents time required for heating in seconds(s). The heating power Pd generated via the electromagnetic induction is calculated as 7.86 kW. A margin of 10% to 15% is incorporated to ensure the heating capacity and requirements in a heating process, giving the final power of 9 kW.

The infrared heating unit 136 is installed on an outer side wall of the heating chamber 132, and includes an infrared heating tube 1360. The external heating tube 1360 is heated by a high-temperature nickel-chromium electric furnace wire, with a power of 5 kW, contributing to a combined total power of 14 kW.

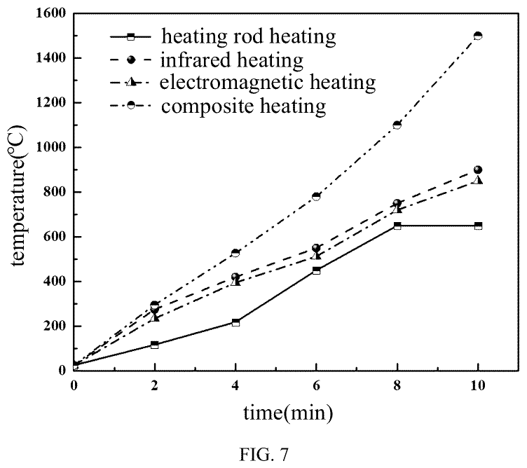

The heating component 130 adopts a composite heating manner of electromagnetic heating and infrared heating. Reference is made to FIG. 7 which shows a schematic comparison view of a single heating manner and a composite heating manner according to an embodiment of the present disclosure. It can be seen that the composite heating manner has high heating efficiency, and can enable the temperature to be quickly increased to 1500° C. within 10 minutes while providing heating uniformity.

In some embodiments, a cooling cover plate 1230 is disposed on an upper surface of the supporting base 123 to thermally isolate heat inside the heating chamber 132 in the compression molding process.

In some embodiments, temperature sensors 1220 and 1240 are respectively installed on the upper mold 122 and the lower mold 124 for detecting a temperature inside the heating chamber 132 in the compression molding process.

The cooling component 140 includes a water cooling unit 142 and an air cooling unit 144.

Among them, the water cooling unit 142 includes a furnace body water cooling plate 1422 and a cold water pipe inlet 1424 which are arranged outside the heating chamber. Injecting circulating cooling water into the furnace body water cooling plate 1422 through a cold water pipe 1424 can thermally isolate the heat inside the heating chamber 132 during the operation of the heating component 130, and cool the heating chamber 132 when the heating component 130 is turned off.

The air cooling unit 144 includes a gas injecting port 1440 disposed on the supporting base 123, and a compression molding supporting rod 1442 provided with a gas flow valve and a gas guiding tube. The gas injecting port 1440 is communicated with the heating chamber 132 through the supporting base 123. The compression molding supporting rod 1442 penetrates through the heating chamber. In compression molding, annealing and cooling stages, cooling gas is injected from the gas injecting port 1440 to rapidly cool optics made of the silica glass 200. Subsequently, the cooling gas is discharged through the compression molding supporting rod 1442. Preferably, the cooling gas can be nitrogen.

The vacuum pumping component 170 is installed on the supporting base 123 and communicated with the heating chamber 132 through the supporting base 123 for evacuating air inside the heating chamber 132 before the compression molding is started. As such, the vacuum molding is achieved, the internal air-induced problems such as restricted flow of the silica glass 200 within a mold cavity and mold oxidation during the compression molding are avoided, and the problems such as incomplete filling and low surface figure accuracy in the glass compression molding process are solved.

The braking component 150 includes a base 152, a plurality of vertically movable guiding rods 154, and a lifting cylinder 156, wherein the heating chamber 132 is connected to the base 152, the base 152 is configured to cooperate with the guiding rod 154, the guiding rod 154 is connected to the lifting cylinder 156, and the heating chamber 132 can move up and down under an action of the lifting cylinder 156.

A buckling unit 1230 is disposed on the supporting base 123 and configured to fix the heating chamber 132 to the supporting base 123 through the buckling unit 1230 when the heating chamber 132 is moved by the braking member 150 until an upper portion of the heating chamber 132 is in contact with the supporting base 123. Preferably, the buckling unit 1230 is a motor-driven positioning buckle capable of rotating 360 degrees.

The stand component 160 is fixedly installed on the compression molding apparatus bottom plate 190 by a supporting I-beam 180.

The silica glass compression molding apparatus 100 provided by this embodiment forms a composite heating system by means of the electromagnetic heating unit 134 and the infrared heating unit 136. The composite heating system enables a temperature inside the heating chamber to quickly exceed 1500° C. within 10 minutes while achieving superior heating temperature uniformity. Compared with an existing compression molding device, the silica glass compression molding apparatus solves the problem that an existing glass compression molding device cannot reach 1500° C. while providing high heating efficiency.

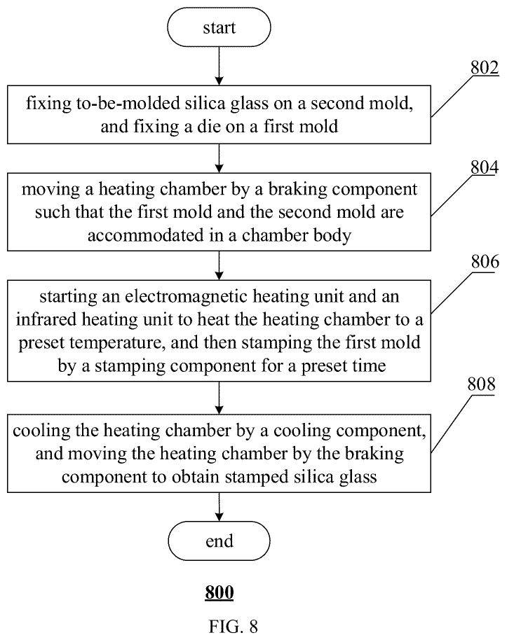

FIG. 8 shows a silica glass compression molding method 800 according to an embodiment of the present disclosure. The method 800 is applied to the silica glass compression molding apparatus 100, and includes:

S802: fixing to-be-molded silica glass on a second mold, and fixing a die on a first mold.

S804: moving a heating chamber by a braking component such that the first mold and the second mold are accommodated within a chamber body.

S806: starting an electromagnetic heating unit and an infrared heating unit to heat the heating chamber to a preset temperature, and then stamping the first mold by a stamping component for a preset time.

S808: cooling the heating chamber by a cooling component, and moving the heating chamber by the braking component to obtain stamped silica glass.

It should be noted that a working principle and process of the method 800 provided in this embodiment are similar to those of the apparatus 100 mentioned above. For corresponding details, reference is made to the description of the apparatus 100, which will be omitted here.

In the description provided herein, a large number of specific details are explained. However, it should be understood that embodiments of the present disclosure can be embodied without these specific details. In some examples, well-known methods, structures and technologies are not shown in detail to avoid obscuring the understanding of the description.

Similarly, it should be understood that in order to simplify the present disclosure and aid in understanding one or more aspects of the present disclosure, various features of the present disclosure are at times grouped together into a single embodiment, figure or description thereof in the above description of exemplary embodiments of the present disclosure. However, the disclosed method should not be interpreted as reflecting the intention that the claimed present disclosure requires more features than those explicitly stated in each claim. Therefore, claims following the detailed description are explicitly incorporated into the detailed description, wherein each claim itself stands as a separate embodiment of the present disclosure.

Those skilled in the art should understand that modules, units or assemblies of the device in an example disclosed herein can be arranged in the device described in this embodiment, or alternatively can be located in one or more devices different from that in this example. The modules in the previous example can be combined into one module or further can be divided into multiple sub-modules.

Those skilled in the art should understand that the modules in the device in embodiments can be adaptively changed and disposed in one or more devices different from that in this embodiment. The modules, units or assemblies in the embodiments can be combined into one module, unit or assembly. In addition, they can be divided into multiple sub-modules, sub-units or sub-assemblies. All features disclosed in the description (including appended claims, abstract and figures) and all processes or units of any method or device so disclosed may be combined in any combination, except that at least some of these features and/or processes or units are mutually exclusive. Unless otherwise explicitly stated, each feature disclosed in the description (including accompanying claims, abstract and figures) may be replaced by alternative features providing the same, equivalent or similar purpose.

In addition, those skilled in the art can understand that although some embodiments described herein include certain features included in other embodiments rather than other features, the combination of features of different embodiments implies that they are within the scope of the present disclosure and form different embodiments.

As used herein, unless otherwise specified, the use of ordinal numbers such as “first”, “second”, “third”, and the like to describe ordinary objects only indicates different instances involving similar objects, and is not intended to imply that such described objects must have a given order (temporal, spatial, ordinal, or otherwise).

Although the present disclosure has been described based on a limited number of embodiments, those skilled in the art will appreciate from the above description that further embodiments may be contemplated within the scope of the present disclosure described herein. Furthermore, it should be noted that languages used in the description are primarily chosen for readability and teaching purposes, rather than for the purpose of delineating or limiting the subject matter of the present disclosure. Therefore, many modifications and changes are apparent to those skilled in the art without departing from the scope and spirit of the appended claims. Regarding the scope of the present disclosure, the disclosure is intended to be illustrative, not restrictive. The scope of the present disclosure is defined by the appended claims.

1. A silica glass compression molding apparatus, comprising:
a mold, a stamping component, a heating component, a cooling component and a braking component,
wherein the mold comprises a first mold and a second mold with molding surfaces, the first mold and the second mold are arranged opposite to each other, and the first mold is disposed above the second mold;
the stamping component comprises a pressing unit for stamping the first mold;
the heating component comprises a heating chamber, an electromagnetic heating unit and an infrared heating unit, wherein the electromagnetic heating unit is wound on the first mold and the second mold, the infrared heating unit is disposed on the heating chamber, and the heating chamber is configured to accommodate the first mold and the second mold within a chamber body under the control of the braking component;
a supporting base is arranged between the pressing unit and the first mold, and when the first mold and the second mold are accommodated within the heating chamber, the heating chamber is abutted against the supporting base to form a closed environment; and
the cooling component comprises a water cooling unit and an air cooling unit, wherein the water cooling unit is arranged on an outer side wall of the heating chamber, the air cooling unit is arranged on one side of the supporting base away from the first mold, and the air cooling unit delivers cold air into the heating chamber through a via hole provided in the supporting base.

2. The apparatus of claim 1, further comprising:
a vacuum pumping component arranged on one side of the supporting base away from the first mold, wherein
the vacuum pumping component is configured to evacuate air in the heating chamber when the first mold and the second mold are accommodated within the heating chamber, such that a vacuum environment is formed within the heating chamber.

3. The apparatus of claim 1, further comprising:
a cooling cover plate arranged on one side of the supporting base away from the first mold.

4. The apparatus of claim 1, wherein the stamping component further comprises:
a servo motor connected to the pressing unit and configured to drive the first mold via the pressing unit to move towards close to or away from the second mold.

5. The apparatus of claim 4, wherein a pressure sensor is connected to an electric cylinder shaft of the servo motor for detecting a compression molding force in a compression molding process.

6. The apparatus of claim 1, wherein temperature sensors are arranged on the first mold and the second mold for detecting a temperature within the heating chamber in the compression molding process.

7. The apparatus of claim 1, wherein a buckling unit is disposed on the supporting base and configured to fix the heating chamber to the supporting base when the first mold and the second mold are accommodated within the heating chamber.

8. The apparatus of claim 4, further comprising a stand component, wherein the stand component comprises a first platform, a second platform and a plurality of supporting columns for supporting the first platform and the second platform, the first platform and the second platform are arranged opposite to each other, the first platform is located above the second platform, and the heating chamber and the supporting base are arranged between the first platform and the second platform.

9. The apparatus of claim 8, wherein the servo motor is arranged outside the stand component, and a channel is formed on the first platform for the electric cylinder shaft of the servo motor to pass through, and a guiding and positioning sleeve is disposed at a contact point between the electric cylinder shaft of the servo motor and the first platform for preventing an axial play of the pressing unit in the compression molding process.

10. The apparatus of claim 8, further comprising a supporting I-beam and a compression molding apparatus bottom plate, wherein the stand component is fixed on the compression molding apparatus bottom plate through the supporting I-beam.

11. A silica glass compression molding method applied to the silica glass compression molding apparatus of claim 1, comprising:
fixing to-be-molded silica glass on a second mold, and fixing a die on a first mold;
moving the heating chamber by the braking component such that the first mold and the second mold are accommodated within a chamber body;
starting an electromagnetic heating unit and an infrared heating unit to heat the heating chamber to a preset temperature, and then stamping the first mold by the stamping component for a preset time; and
cooling the heating chamber by the cooling component, and moving the heating chamber by the braking component to obtain stamped silica glass.
